(19) United States
(12) Patent Application Publication
(10) Pub. No.: US 2003/0137506 A1
(43) Pub. Date: Jul. 24, 2003

(54) Image-based rendering for 3D viewing

(76) Inventors: Daniel Efran, Pittsburgh, PA (US); Mark Ollis, Pittsburgh, PA (US); Todd A. Williamson, Philadelphia, PA (US)

Correspondence Address: Wen Liu, LIU & LIU, Suite 1100, 811 West 7th Street, Los Angeles, CA, 90017, US

(21) Appl. No.: 10/307,574

(22) Filed: Nov. 27, 2002

Related U.S. Application Data
(60) Provisional application No. 60/337,863, filed on Nov. 30, 2001.

(51) Int. Cl. G06T 15/00

(52) U.S. Cl. 345/419

(57) ABSTRACT

An image-based rendering system and method is disclosed for displaying 3D images of a subject (e.g. an object or scene). A compressed image file having multiple corrected and calibrated images of a subject from various viewpoints from along a trajectory about the subject is generated. Prior to selected viewpoints of the object being displayed, the compressed image file is at least partially transcoded to a randomly accessible format such that individual or multiple images may be extracted for immediate display or further processing. One or more final extracted images are optionally used in interpolation, morphing, or stitching algorithms before display to a viewer.

This application makes a claim of priority from U.S. Provisional Application No. 60/337,863 (attorney docket no. 1030/206), entitled “Image-Based Rendering for 3D Object Viewing,” filed Nov. 30, 2001 in the names of Efran et al, which is incorporated by reference as if fully set forth herein.

### BACKGROUND OF THE INVENTION

1. Field of the Invention

This invention relates generally to a system and method for creating three-dimensional images of a subject (e.g. object or scene). Particularly it relates to the capture, processing, and compression of multiple images into a file, and generation of three-dimensional images of the subject from the compressed image file via a transcoded intermediate file.

2. Description of Related Art

The use of three-dimensional (3D) digital imaging of objects has become widespread in consumer oriented business applications, such as online advertising and shopping applications in the so-called “digital commerce” space. The primary reason for such proliferation is the desire of consumers to view potential items for purchase from multiple viewpoints, thus recreating in part the experience the consumer would have had in a traditional “brick and mortar” store. Existing technologies for rendering 3D object views fall into two broad categories. The first method (Method A) involves capturing and storing many discrete images of an object. When the user selects a particular viewpoint of the object, the stored image (generally in a compressed format to save space) which was captured from a position closest to that viewpoint is recalled and displayed. Applications such as QuickTime™ VR Object Movies (owned by Apple™ Computer, Inc.) use this approach. There are a number of general-purpose compression algorithms already in use for such image sequences. Some are designed to compress a single frame at a time (e.g.

JPEG or GIF format), while some are designed to compress sequences of frames (e.g.

MPEG, VP3, and Sorenson formats).

Another approach that has been used for displaying 3D objects is texture-mapped polygonal modeling (Method B). In this approach, a 3D polygonal model of the object is first constructed, often using either a laser light striper or a scanning laser rangefinder. 3D models may also be created by hand using specialized computer software. A set of images of the object are then captured and registered to the 3D model. Using these images, an image texture is extracted for each polygon. Storing an object as a polygonal model and a set of texture maps is very common in a wide variety of software applications, such as VRML viewers and video games. These models can be stored very compactly, and they can be viewed from arbitrary viewpoints. Examples of texture-mapped polygonal modeling are the object capture systems by Geometrix™ or Dimension 3D™.

Both of the above 3D imaging methods are lacking however, especially in their ability to provide highly compressed (small file size) 3D images of an object which are photo realistic in quality. For instance, the 3D model approach of Method B above becomes increasingly difficult and time consuming depending on the physical characteristics of the object being modeled. It is also rarely the case that significantly realistic 3D representations of the object are yielded within applicable file size requirements such that photo realistic images of the object are displayed at all desired viewpoints. Particularly, objects modeled with this method lack such immersive photographic characteristics as sparkle, brilliance, and reflections on the object. Likewise, method A described above suffers from unacceptably large file sizes for most digital commerce applications, and additionally suffers from lack of sufficient image quality if file sizes are compressed within acceptable limits. It is also the case that many desired viewpoints are not possible using Method A given that a limited number of discrete images must be displayed to a viewer without providing for arbitrary selection and display of any viewpoint. It is also difficult for such systems to adequately represent glass or jewelry objects, and other translucent, transparent, and/or shiny objects given the number of images necessary to realistically depict such items.

It would be desirable to provide a system capable of capture, processing, and compression of multiple images of an object from different viewpoints, and the selective display of those and similar viewpoints of the object or scene from the compressed images such that 3D representations of the object are possible with reduced file size and image creation effort. There is therefore a need for providing a system and method for the generation of high quality yet with small file size 3D images of an object or scene which overcomes the shortcomings in the prior art.

### SUMMARY OF THE INVENTION

The present invention is directed to an image capture, processing and compression system for image-based rendering of 3D objects for viewing from multiple viewpoints, which overcomes drawbacks in the prior art. The Image-based rendering system of the present invention allows for the generation of high quality 3D images of objects for viewing from multiple viewpoints with increased image compression and ease of image capture and creation. High quality images of an object from an image capture device are captured from multiple viewpoints using an image capture system and associated “create” process, and stored on a computing device for 3D image generation and display. Image correction and calibration processes are performed on each image based on user adjustable parameters, and the background of each image surrounding the object is selectively removed using a background subtraction algorithm. Images are compressed using available sequential image compression techniques, such as MPEG, AVI, or similar compression methods, and stored on the fixed storage medium of the computing device. During 3D image display, the compressed image file is transcoded into a second (intermediate) compressed format wherein individual, or groups of images may be made available to an image display and/or interpolation algorithm for 3D display of the object from multiple viewpoints. By using appropriate data transcoding methods, the initial file size of the first compressed image file may remain very small, and need not be presented in a fully decompressed, or sequential fashion in order to generate high quality output images from multiple viewpoints. An optional GUI is provided during the create process to allow for using definable image capture settings, as well as manipulation of color corrections, calibrations, and background subtraction processes. In addition, a GUI is provided during the display process for user interactions with the completed 3D object file, such as selection of object viewpoint, object zoom and orientation.

In one aspect of the present invention there is provided an image capture system for providing images of a subject (e.g. an object or scene) to be used in the create and display processes of the current invention.

In one embodiment, the image capture system is configured to capture images of a particular object or objects, and includes an image capture device, support rig, object stage, optional remote image transferring means, and a computing device for receiving, storing, and processing captured images from the image capture system.

In another embodiment, the image capture system is configured to capture images of a scene (generally in an arcuate or panoramic fashion), and includes an image capture device, rotatable support rig, optional remote image transferring means, and a computing device for receiving, storing, and processing captured images from the image capture system.

In another aspect of the present invention, a create process is disclosed for using the image capture system and computing device to capture high quality images of a subject object or scene, and then correct, calibrate and compresses the captured images into a digital file.

In one embodiment of the create process of the current invention, includes performing image correction and/or calibration procedures are performed on the captured images for enhancing the appearance and continuity of captured images, as well as a background subtraction proceedure for decreasing the resultant compressed digital file size containing the enhanced images. The background subtraction means includes a computer implemented background subtraction algorithm for modeling the background color distribution of an image by sampling edge pixels from the image, computing the Mahalanobis distance between each pixel and the model resulting in a score for that pixel, and blending the background color with each pixel in proportion to it's score. The blending amount may be controlled by a user to finely tune the overall background subtraction effect.

In yet another aspect of the present invention, a display method for displaying various viewpoints of an object or scene using the compressed digital file is provided wherein the initial compressed digital file is transcoded to a second compressed format such that the captured images within are randomly accessible by an image display means. Using this method is it possible to keep highly compressed digital files in the fixed storage of a computing device, and transcode the compressed digital files into a randomly accessible compressed format in the memory of that or another computer device for further image processing and display.

In one embodiment of the display method of the present invention, a randomly accessible transcoding compression format is used such that individual images from a compressed dataset can be decompressed without having to decompress additional neighboring images.

In another embodiment of the display method or the present invention, image interpolation and morphing methods are used for generating new viewpoints of the object or scene which are not represented by any initially captured images. Given an interpolation or morphing algorithm of sufficient ability and quality, inclusion of interpolated images (or use of interpolated images alone) may create more desirable display image appearance, require fewer cameras to accomplish a given effect, or a combination of the above.

In still a further aspect of the present invention, a graphic user interface (GUI) is provided on one or more computing devices for management, manipulation, and user interaction during the create and display processes. Operators may set parameters before and/or during object capture which dictate the quality, compressed size, and other aspects of the 3D captured object image. During display, viewers may specify desired viewpoints for display, and interact with the object image to modify its size, orientation, and other characteristics. The same GUI may be used for both create and display processes, however it may be desirable to use separate GUI's for create and display processes, such that an operator may use the create GUI to generate the initial compressed image files, and remote users may use a separate display GUI to view and interact with the compressed image files.

This invention has been described herein in reference to various embodiments and drawings. While this invention is described in terms of the best presently contemplated mode of carrying out the invention, it will be appreciated by those skilled in the art that variations and improvements may be accomplished in view of these teachings without deviating from the scope and spirit of the invention. This description is made for the purpose of illustrating the general principles of the invention and should not be taken in a limiting sense.

### BRIEF DESCRIPTION OF THE DRAWINGS

For a fuller understanding of the nature and advantages of the present invention, as well as the preferred mode of use, reference should be made to the following detailed description read in conjunction with the accompanying drawings. In the following drawings, like reference numerals designate like or similar parts throughout the drawings.

FIG. 1 is a schematic diagram showing the image capture system architecture.

FIG. 2 is a schematic diagram showing the compression and transcoding scheme of the current invention.

FIG. 3 is a schematic diagram showing an example system according to the current invention.

FIG. 4 is a schematic block diagram illustrating the create process steps of the current invention.

FIG. 5 is a process flow diagram illustrating the display process steps of the current invention.

FIG. 6 illustrates the Create GUI of the current invention.

FIG. 7 illustrates the Create GUI control panel of the current invention.

FIG. 8 illustrates the saving and restoring of post-processing parameters according to the current invention.

FIG. 9 illustrates the adjustment of images according to the current invention.

FIG. 10 illustrates the modification of image boundaries in the Create GUI.

FIG. 11 illustrates the background subtraction adjustment GUI.

FIG. 12 illustrates the color balance adjustment GUI.

FIG. 13 illustrates the export GUI dialogue box.

### DETAILED DESCRIPTION OF THE PREFERRED EMBODIMENT

The present description is of the best presently contemplated mode of carrying out the invention. This description is made for the purpose of illustrating the general principles of the invention and should not be taken in a limiting sense. The scope of the invention is best determined by reference to the appended claims.

All publications referenced herein are fully incorporated by reference as if fully set forth herein.

The present invention can find utility in a variety of implementations without departing from the scope and spirit of the invention, as will be apparent from an understanding of the principles that underlie the invention. It is understood that the image-based rendering concept of the present invention may be applied for digital commerce, entertainment, sports, military training, business, computer games, education, research, etc. It is also understood that while the present invention is best explained in reference to a fly-around type view of a particular object, the amount of particular image visualizations made possible by this system, including angular or panoramic images of a scene, 3D object representations, or otherwise, is virtually limitless.

System Overview:

The Image-based rendering system of the present invention allows for the generation of high quality 3D images of a subject (e.g. an object or scene) for viewing from multiple viewpoints with increased image compression and ease of image capture and creation. High quality images of an object or scene from an image capture device are captured from multiple viewpoints using an image capture system and associated “create” process, and stored on a computing device for 3D image generation and display. Image correction and calibration processes are performed on each image based on user adjustable parameters, and the background, or extraneous portions of each image surrounding the object or scene may be selectively removed using a background subtraction or similar algorithm. Images are compressed using available sequential image compression techniques, such as MPEG, AVI, or similar compression methods, and stored on the fixed storage medium of the computing device. During 3D image display, the compressed image file is transcoded into a second (intermediate) compressed format wherein individual, or groups of images may be made available to an image display and/or interpolation algorithm for 3D display of the object or scene from multiple viewpoints. By using appropriate data transcoding methods, the initial file size of the first compressed image file may remain very small, and need not be presented in a fully decompressed, or sequential fashion in order to generate high quality output images. An optional GUI is provided during the create process to allow for using definable image capture settings, as well as manipulation of color corrections, calibrations, and background subtraction processes. A GUI is provided during the display process for allowing viewing and interaction by a user of the subject.

Throughout the following detailed description of the invention, various references to a subject, object or scene are made interchangeably, and generally refer to the subject of image capture whether it be a particular object or objects depicted from multiple surrounding angular viewpoints (relative to the image capture device), or a scene or setting depicted across multiple rotational, angular, or translational viewpoints (relative to the image capture device). Additionally, for convenience and explanatory purposes, various embodiments of the present invention include detailed descriptions of a singular object depicted from multiple viewpoints, and should not be taken as limiting depictions of multiple objects, scenes, settings, or other subjects of image capture. It will be further understood that many camera trajectories (including circular, ellipsoidal, arcuate, translational, or other trajectories apparent or virtual), rotations, and movements are possible for the purpose of capturing images to be used with the current invention, without limiting the spirit and scope of the present invention.

System Hardware

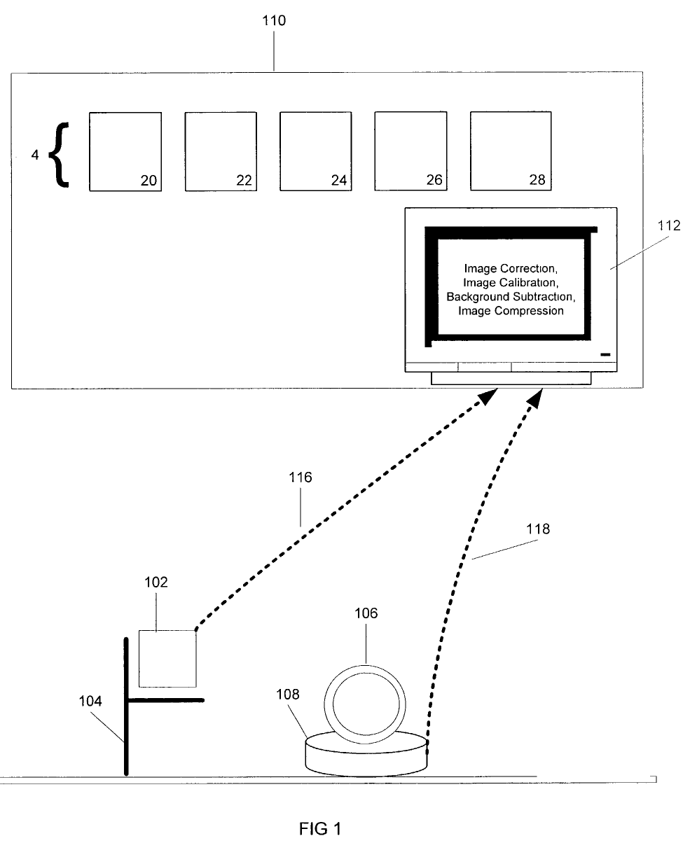

Looking now to FIG. 1, the image capture system of the current invention is shown schematically. In general, the system comprises a subject (object 106 in the illustrated system) to be captured (the subject is not essential to system operation) and displayed using the 3D display process of the current invention, object stage 108 for rotating the object during image capture, capture device 102, capture device support 104 for maintaining capture device 102 in a fixed position during image capture, and computing device 110 for performing storage, processing, and display functions of the 3D image rendering process. According to the current invention, the position and orientation of the object 106 with respect to the capture device 102 must be known. This is accomplished by mounting a capture device, or the object to be captured, on a device which changes the position and orientation of the camera and/or object in a controlled manner. Object 106 may be any object to be captured from multiple viewpoints according to the current invention, including objects having high reflective characteristics or transparency, such as jewelry or glass/crystal items. The size of object 106 is only limited by the ability of the object stage 108 to rotate object 106 such that images from multiple viewpoints about object 106 may be captured by capture device 102. It will be understood and appreciated by those skilled in the art that object 106 is not a functional component of the image capture system, and is not necessary for its operation. Conversely, capture device support 104 may be a moveable device such that the capture device 102 itself can rotate about object 106 to capture images from multiple viewpoints. The object stage 108 may be any commercially available object rotation device such as the Kaidan™ Magellan 2500 object rig or the Kaidan™ Magellan desktop object stage which is capable of rotating with respect to surface on which it is placed. According to one embodiment of the present invention, capture device 102 is a high quality (3 megapixels or higher) digital camera capable of capturing images 4 of the object 106 and storing them in a digital file format (such as JPG, BMP, TIFF, or RAW). Computing device 110 is preferably an IBM compatible PC (though may be any computing device) capable of running image enhancement, compression, and interpolation algorithms. Computing device 110 is shown operatively connected to both capture device 102 and object stage 108 via communication links 116 and 118 respectively. Communication links 116 and 118 are both serial communication links in one embodiment of the present invention, but may be any communication link including wireless links (WiFi, Bluetooth, IrDa), Firewire, or similar link. According to one embodiment of the present invention, computing device 110 is able to control the timing and operation of both capture device 102 and object stage 108 in this configuration using software (not shown) such that precisely timed captured images 4 of object 106 at well defined points about object stage 108's motion path (i.e. rotational path) are possible. The software (not shown) on computing device 110 is configured to capture position information (generally in latitudinal and longitudinal position coordinates, relative to an imaginary sphere surrounding object) corresponding to each captured image. Such position information can be used during the create and display processes, for instance, in situations where image interpolation is to be used to generate final output images according to the current 3D image display method, it is preferred to capture images from about object 106 at 10 degree increments. Such position information from each image is provided to the interpolation algorithm during display for processing interpolated images. During image display, the captured position information for each image may be used to quickly display a desired viewpoint of the object to a user.

For some implementations of the present invention, particularly when using interpolation or morphing routines during display, it may be necessary to very accurately calibrate the capture system. Such accurate calibration can generally be accomplished using machine-readable markers (such as checkerboard or bar code type markers) placed on the object stage 108 to aid in a control software (not shown) determination of the relative positions of the capture device 102 and object stage 108 via known methods.

GUI 112 shown in FIG. 1 is an optional element to enable increased operator interaction with the capture system properties and parameters, and is described in greater detail below.

Create Process:

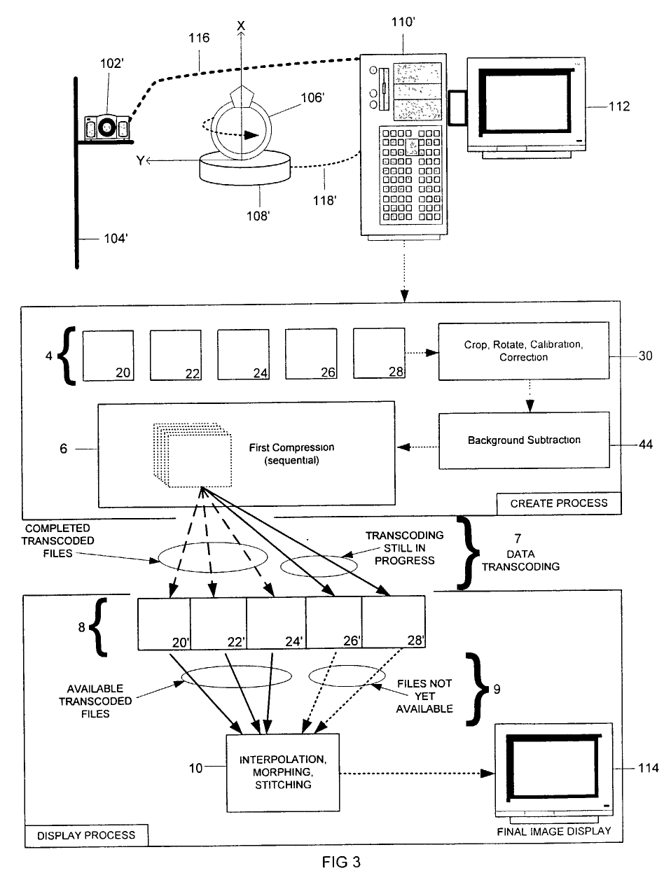

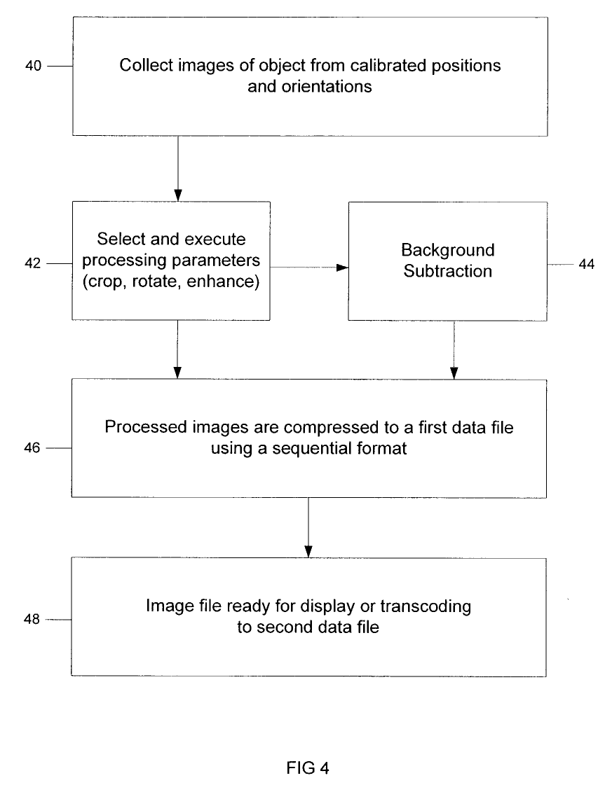

FIG. 4 illustrates a schematic block diagram showing the general create process. In step 40, a set of images 4 of the object are collected. As described above, the collected set of images are preferably taken from calibrated positions, that is, the position and orientation of the object with respect to the capture device must be known. This is accomplished by mounting a digital camera, and the object to be photographed, on a calibrated device (generally the moveable camera rig or support structure and the moveable object stage). Once position and orientation data for the camera and object are known, such information may be stored with each captured image 20-28 for enabling other image processing functions, such as image correction and interpolation, and selection of an appropriate image given a selected viewpoint during the display process. The storage of positional information for each image may be accomplished using a spreadsheet, database, or as data appended to the image file itself. It is well within the abilities of those skilled in the art to accomplish the storing of position information in conjunction with each captured image such that the information can be retrieve during later processing and viewing procedures. The camera rig and object stage should generally be able to change the position and orientation of the camera and/or object in a controlled manner. For instance, the object 106 may be supported on an object stage 108 (see FIG. 3), and rotated 360 degrees about the X-axis during capture. Such rotation during capture may be used to produce a fly-around view of the object 106 from a particular angular viewpoint (generally level with the midpoint of object 106, as shown in FIG. 3). Additionally, object 106, or capture device support 104 may be angularly oriented (not shown) with respect to the Y-axis such that a second 360 degree fly-around view (about the X-axis) of object 106 may be generated from a different angular viewpoint. Further fly-around views of object 106 may be captured using a similar technique in order to generate multiple viewpoints along both latitudinal and longitudinal coordinates surrounding object 106. For each captured image, the latitudinal and longitudinal position information would be stored as described above so that appropriate images may be displayed to a view during the display process corresponding to the viewers desired selection. It will be understood and appreciated by those skilled in the art that virtually unlimited orientations of capture device support 104 and/or object 106 on object stage 108, along multiple axes, may be used to capture images for use in the present invention. Both this moveable device, and the capture device, may be linked to the computing device such that the computer can control their movement and functions. In such a case, the computer sends commands to the camera and the moveable device in order to take a range of pictures of the object. As described above, for each picture, the position and orientation (generally latitudinal and longitudinal position information) of the camera relative to the object is stored on the computer, as well as the image itself.

In step 42, the processing parameters are selected via the GUI and then executed on the images. This step allows adjustments to be made to the set of images collected in step 40. For example, the images can be cropped, repositioned, and adjustments to the brightness, contrast, and color made in this step. This is also the point in the process where the background subtraction 44 is optionally performed, and where the user can fine-tune the parameters that control background subtraction, such as background blending.

The background subtraction algorithm generally works by generating a model of the background color distribution is created by sampling the pixels around the edge of the image, computing the Mahalanobis distance between each pixel and the model resulting in a score for that pixel, and blending that pixel with the background color in proportion to the computed score. There is a single user control that can magnify or diminish this blending. The background subtraction method of the current invention is described in greater detail below, however, it will be understood and appreciated by those skilled in the art that any number of known background subtraction algorithms may be used to remove extraneous areas of the captured image files in order to reduce file size and more clearly display the captured object from multiple viewpoints according to the current invention.

In step 46, the captured and calibrated images are compressed to a data file 6. In this step, the data is compressed into a very small file format, using any of a number of available compression algorithms, such as MPEG4. Since the compressed images do not need to be randomly accessed in this step according to the present invention, the resulting file size can be extremely small compared to the original size of the captured images. For instance, compression algorithms such as the MPEG4 algorithm compress image data based on the difference between successive images contained in the file rather than compressing every single image file, which results in extremely small file sizes of the original files (files can be compressed to on the order of 10-15% of their original size). Files in these formats are generally sequentially displayed, or streamed, and as such, individual images may not be randomly accessed from within the compressed file without fully decompressing the file. For additional description and specification of the MPEG4 standard, see “MPEG-4 Overview—(V.21—Jeju Version)” Edited by Rob Koenen, ISO/IEC JTC1/SC29/WG11 N4668 (March 2002) [http://www.m4if.org/resources/Overview.pdf]. At this point, the capture process is complete, and a highly compressed data file containing the captured image data resides on the computing device, generally in the fixed storage of the computing device (i.e. hard drive, CDROM, or other fixed storage media).

In step 48, the highly compressed data file 6 (using a non-random access format such as MPEG4 or similar format) containing information from the captured images 4 is ready for immediate display to a user (though such display would be sequential and not random-access), or according to the current invention, transcoding to an intermediate image compression format 8 for increased functionality during final image display.

Display Process:

FIG. 5 shows a block schematic diagram of the general display process of the current invention. The display process consists of two sub-processes, both being executing concurrently in one embodiment, in order to generate the rendered images to a viewer.

In the first sub-process 52, data from the original compressed file 6 is transcoded into a memory format that will allow random access to the image data, such that an image in the middle of the dataset can be decompressed without having to decompress any of its neighbors, or the entire sequence of images. The resulting dataset is larger than the original compressed data file, but still smaller than the original set of input images. The transcoding process 7 is generally initiated prior to, and can also be performed concurrently with, the display of desired images to a user, such that the initial compressed file 6 present on the users computer system is transcoded to the second compressed format 8 prior to or upon receiving the users request for a particular viewpoint to be displayed using the user interface. In some cases, or if so desired, images may be readily displayed to a user following the transcoding process, however, to achieve the greatest number of available object viewpoints for display to a user, it may be desirable to perform image interpolation, morphing, or stitching concurrently in the display process as described below. For instance, in the case where a user requests a viewpoint corresponding to an existing image file in the second compressed file 8, that image may be immediately displayed to the user. For requested viewpoints not having corresponding images present in the second compressed file 8, an image closest to that viewpoint may be displayed, or optionally the second sub-process outlined below may be performed.

The second sub-process 54, involves optional image selection 9 from the second data format 8, and interpolation, morphing or stitching 10 of the selected images to a final rendered image to be made available to a viewer 56. Generally for this process, the user requests a particular viewpoint, using a user interface on the computing device, or any computing device to which the compressed image file has been transferred or placed. The nearest set of N input images (generally 2 images for interpolation processes, however more may be used to improve interpolation results) to this viewpoint are decompressed (shown at 9) in the memory of the computing device (i.e. RAM). Using any of a set of available interpolation or morphing algorithms 10, an approximation of the image corresponding to the user's choice of viewpoint is constructed. This interpolated image is then displayed to the user. As described above, in order for the interpolated images to be of satisfactory quality, the original input images should be taken at a fairly close angular spacing: e.g., every ten degrees. By neglecting the interpolation step and forcing the viewer to select between discrete viewpoints, this angular spacing requirement can be avoided. It will be understood by those skilled in the art that the current invention need not make use of any interpolation or morphing techniques in order to generate output images of an object for viewing.

In step 58, the final output image is displayed to the user, either directly from the second compressed file 8, or after processing in steps 54 and 56.

Image Correction, Calibration, and Background Subtraction

Due to inherent limitations in the ability to perfectly calibrate cameras, aberrations in lighting and other ambient system characteristics, and the image deviations introduced during image capture due to system disturbances and/or perturbations, it may be necessary to perform certain adjustments on each original captured image to be used in a the final 3D object file prior to or during the create process in order to produce output images of sufficient quality for use in digital commerce or other applications.

The image adjustment process differs from the camera and stage calibration or positioning procedures that are performed before actual images are captured by the system. As much as possible it is desirable to initially position the camera and object stage very precisely in order to create the smoothest most uniform 3D images possible without image adjustment. Due to factors such as those mentioned above however, even in very precisely positioned camera and object stage system captured images may require further processing and calibration prior to rendering of 3D images.

Generally during calibration and processing, the images can be cropped, repositioned, and color-adjusted. Each image may also undergo background subtraction in order to reduce the resultant file size of the compressed image file and enhance the appearance of captured object(s) in the image.

The background subtraction algorithm generally works as follows:

A) A model of the background color distribution is created by sampling the pixels around the edge of the image. When using the image capture system of the current invention, it will generally be the case that such edge pixels represent background color, thus sampling pixels from the image edge will yield the background color which is to be subtracted.

B) The Mahalanobis distance (a well known algorithm for of determining the “similarity” of a set of values) is computed between each pixel and the model, resulting in a score for that pixel.

C) The pixel is blended with the background color in proportion to the score computed in part B. There is a single user control that can magnify or diminish this blending.

One key advantage to using the above background subtraction technique, especially when using compression algorithms which rely on the difference between successive frames (such as MPEG4), is that the background is not excluded as in “mask” type routines (which are sensitive to errors), but rather is made more uniform in color, which improves the overall compression ratio of the files in the first compressed format.

It will be understood and appreciated by those skilled in the art that any number of known background subtraction algorithms may be used to remove extraneous areas of the captured image files in order to reduce file size and more clearly display the captured object from multiple viewpoints according to the current invention.

The Example System discussion contained below describes the image creation process, including calibration and background subtraction in greater detail.

Data Transcoding

According to the current invention, image data which has been compressed in an initial compressed format (such as MPEG4) is transcoded to a randomly accessible format prior to the rendering of images for viewers of particular viewpoints. In order to perform such transcoding it is necessary to dynamically adapt, reformat and filter the compressed data file such that a new secondary compressed data file is generated having the desired new data format. According to the present invention, any data format may be used for the transcoded data which allows random access to individual or groups of images within the compressed image file (such as the Zip, Rar, Arj, or similar compression formats). In one example system, images from the initial compressed file (generally in MPEG4 or similar format) are decompressed to individual uncompressed image files in the memory of a computing device, then immediately recompressed to a random access format (such as the Zip format) containing all image files, or to an array of separate compressed image files (such as JPEG files) containing one image each. In another example system, the images from the initial compressed file are decompressed to individual compressed image files (such as JPEG files) directly, which may then be stored in the memory of a computing device, or further compressed in a smaller file size random access format containing all decompressed images (such as the Zip format). The transitional decompressed image files (which are uncompressed as in the first example system above) in memory are discarded immediately after inclusion in the newly created random access compressed file(s) (Zip file, or individual compressed files such as JPEG files), unless they are needed to aid in the decompression of subsequent images from the first sequential compressed file. It may be desirable to use known compression formats (such as MPEG4, JPEG, and Zip) for the sequential, individual image, and random access formats respectively, according to the current invention, given that the function and operation of each is well known. It should also be understood and appreciated by those skilled in the art that alternate compression formats (and ultimately transcoding methods) which do not use standard compression formats, or include individual decompressed images files (from the initial compressed format) may be used according to the current invention.

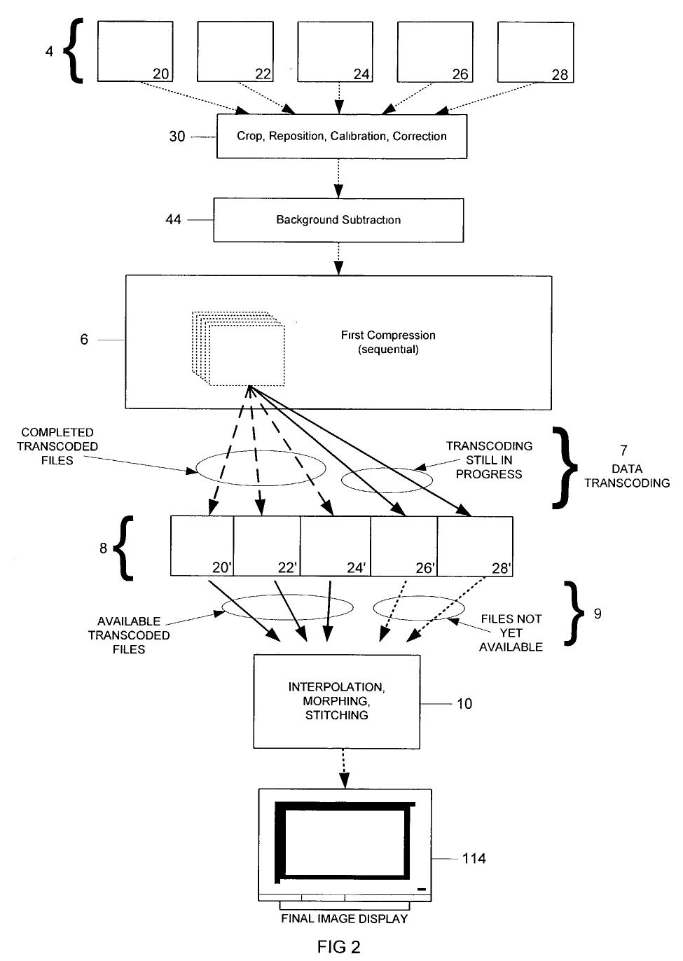

Looking now to FIGS. 2 and 3, the compression and transcoding system of the current invention is shown schematically. Captured images 4 (comprising individual images 20, 22, 24, 26, and 28 which represent different viewpoints of object 106) may optionally undergo image adjustment, correction, and calibration routines 30, and a background subtraction routine 44 prior to being compressed in a first sequential image format, such as MPEG, AVI or other known sequential image compression formats which are capable of compressing images 4 into a very small file size (generally 10-15% of their original size). The first sequential compressed image format 6 generally resides on the computing device used during the create process, however compressed image file 6 is portable according to the current invention and may be placed on any computing device, including Internet servers or other network computers for sending to one or more remote computing devices for viewing by a user. Upon initiation of a request to view images from compressed image file 6, including transfer of compressed image file 6 from a server to a remote computer, the image data is transcoded 7 to a second compressed format 8. Such transcoding may take place concurrently with display of the images to a viewer, after the compressed image file 6 has been transferred to the viewer's computer. Compressed image file 6 is shown being progressively transcoded in FIGS. 2 and 3, with some images (20′ 24′) being completely transcoded while other images (26′ and 28′) have not yet been fully transcoded. This illustrates, according to the current invention, how even during the transcoding process (whether performed completely on the viewers computer, or during transfer to the viewers computer) some individual images (whether in the random access compressed format 8, or as transitional image files) may be used in interpolation, morphing, or stitching routines 10, or directly displayed to the viewer. Compressed format 8 contains randomly accessible image files 20′, 22′, 24′, 26′, and 28′, following the completed transcoding process (shown in FIGS. 2 and 3 in progress), which according to the current invention are the counterpart files to initial captured images 20-28. The individual images contained in compressed format 8 may have different resolution and image format characteristics than original images 4, however each counterpart image (i.e. 20 and 20′) will represent the same viewpoint of object 106 according to the current invention. Once the second compressed format 8 has been generated following transcoding 7 (or as transcoding is progressing as described above), individual images may be selected (shown at 9) for further processing such as interpolation, morphing, or image stitching (in the case of panoramic images of a scene) 10. It is also possible to bypass the use of any interpolation, morphing or stitching routines 10 and simply display individual images from compressed format 8 as desired (may be displayed randomly or in a predetermined series). GUI 114 may be used to facilitate final image display (for example, allowing the user to select a desired viewpoint), and as described above, may be the same GUI 112 used for image capture and creation or may be a separate GUI on a remote computer.

Image Interpolation, Morphine, and Stitching

In another aspect of the current invention, image interpolation, morphing, or “stitching” algorithms and techniques may optionally be employed during the final image rendering and generation process as a means to add one or more “intermediate” images between original captured images or generate seamless image panoramas (in the case of image stitching). The interpolation and morphing processes may be useful in that the final output images may be selected by the view from virtually any possible viewpoint from about the object, and are not limited to the discrete images captured by the capture device. They may also be used to reduce the number of captured images needed to display a sufficient number of object viewpoints for a particular application. Generally the body of interpolation algorithms known as Image Based Rendering (IBR), or View Morphing may be used to create the intermediate images which fall between captured images. A detailed description of the process and use of such interpolation functions may be found in “Forward Rasterization: A Reconstruction Algorithm for Image-Based Rendering,” by Voicu Popescu, UNC Dept. Comp. Sciences TR01-019.

In cases where images were captured of a scene rather than an object (such that multiple images covering a predetermined angular area are captured) a “stitch” algorithm may be used to automatically seam together images to create a smooth panorama view of the captured scene. Such stitching algorithms and methods are well known in the art.

User Interface

In a further aspect of the image-based rendering system of the present invention, an optional graphic user interface (GUI) may be included for allowing a human operator to interact with the image create and display processes. In general the user interface system will enable the operator to control the create process from one single computer (host system) while the display process will be controlled by a user at a second remote computer (display system) as is common in digital commerce applications. It is also possible to use the same GUI for both create and display processes if remote viewing of generated 3D image files is not required. The GUI for the create system enables the operator to control various parameters governing the image capture, correction, and compression process such as image cropping parameters, brightness and contrast, color balance, and rotation. The user may also preview images from the capture device at various viewpoints about the object to be captured prior to performing the create process in order to preview a portion of the final 3D image to be generated. The GUI of the present invention is described in greater detail in the Example system section below.

Example System

In one example 3D Image Based Rendering system (shown schematically in FIG. 3), a ring 106′ (may be any object to be captured) is located on rotateable object stage 108′, and digital camera 102′ is shown fixedly attached to camera rig 104′ such that when the object stage 108′ is rotated camera may capture images 4 of object 106′ from multiple viewpoints. Computer 110′ is shown operatively connected to both digital camera 102′ and rotateable object stage 108′ such that control software on computer 110′ may control the their movement, timing and functions. Communication links 116 and 118 are both serial communcation links in the example system, but may be any communication link including wireless links (WiFi, Bluetooth, IrDa, Firewire, or similar link). In one embodiment of the present invention, control software on the computer will cause images to be captured of ring 106′ every 10 degrees by rotating object stage 108′ which supports ring 106′. Prior to and during the capture process, the GUI 112 may be used by an operator to interact with process parameters of the control and image processing software, such as rotation of the object stage, and frequency and angular orientation of captured images. Images 20, 22, 24, 26, and 28 are shown representatively in the computer 110′, and may be transferred to computer 110′ manually or via communication link 116. After image capture and transfer to the computer, the GUI 112 aids in processing and calibration functions 30 which are performed on captured images, such as specifying the image locations, image boundaries, repositioning the image, adjusting image brightness and color balance, background blending (for background subtraction procedure), and image quality. Background subtraction 44 is optionally performed before compressing images into compressed file 6.

A GUI system 112 is implemented on the host system for user/operator interaction with the effect generation process. The display GUI system 114 may be the same GUI system 112 used during the create process, or may a separate GUI system for use by a remote viewer, such as a remote computer system connected to the Internet for downloading of the 3D image file.

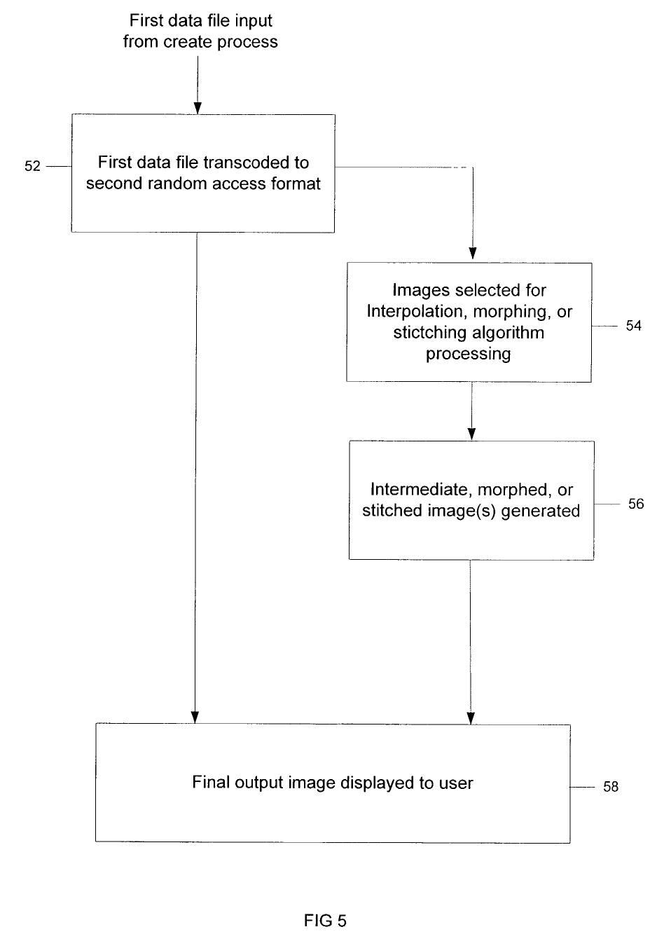

Further detailed references and description of the example system above are made throughout the following sections, but should not be regarded in limiting each aspect as to its function, form or characteristic. Likewise, the example system is meant as purely illustrative of the inventive elements of the current invention, and should not be taken to limit the invention to any form, function, or characteristic. An example create process for generating interactive 3D according to the current invention is detailed below. FIGS. 6-13 illustrate various elements of the create process GUI.

1.0. Data Collection with Capture Script (“zCapture” in the Current Example)

According to the example system, zCapture is the component that allows automatic image capture of an object from a range of angles. The program is driven by script files, however, care must be taken in setting up the camera, object stage and lights for achieving high quality results.

1.1. Studio Layout

For the present example, the best results were obtained using the following guidelines to set up the data capture studio. The studio is configured in a space with full lighting control whenever possible. Uncontrolled ambient light, especially from windows and fluorescent room lights, may result in unacceptable color variation in the resulting images. The object stage is placed on a stable surface, such as a sturdy desk or table, and the object to be photographed is placed in the exact center of the object stage, so that its position will not appear to shift when the object stage rotates. A white backdrop is positioned beneath and behind the object. This ensures that the captured images will not have a distracting background. The camera is placed on a sturdy tripod, as close as possible to the object stage. The camera is pointed directly at the object. The camera lens is at the same height as the object, but it is also acceptable to raise the camera slightly above the level of the object and tilt it downward, if this will provide a better depiction of the object. Lowering the camera below the object (and tilting it upward) is less desirable, as the edge of the object stage may obscure the camera's view of the object. The camera lens is approximately 9 to 12 inches from the object. If the camera is too close, it will be difficult or even impossible to focus the image. If the camera is too far away, the object will occupy a smaller portion of the total image. That will diminish the visual quality of the data set. The object stage's controller (for instance the eMCee™ controller by Kaidan in the current example) is plugged in and turned on, and connected to the computer's serial port. The camera's external power supply is used to guarantee that the camera has power for the entire capture session.

1.2. Lighting

Once the object is positioned on the object stage, it must be illuminated. The backdrop is illuminated evenly, so that its brightness is relatively uniform even as it rotates. Any shadows cast on the backdrop by the object are eliminated or removed by using several soft lights above and around the object stage. A self-illuminated “lightbox” backdrop is another effective approach.

The above constraints notwithstanding, the object itself is illuminated for optimal aesthetic effect. (For example, a gemstone usually looks best with a hard light not too close to the camera creating internal reflections and “sparkle”.)

The camera's color LCD monitor may be used to preview the lighting results. For a more accurate preview, a few test pictures may be captured and downloaded to the computer. The zCapture program may assist with these previews, as detailed below.

1.3. Focus and Exposure

Generally, the cameras focus and exposure settings should be adjusted such that the best quality images are captured. The camera's focus and exposure may be manually set before capturing data, or may be set automatically by the zCapture software.

1.4. Previews with zCapture

When performing the procedures described in above data collection steps, it may be helpful to rotate the object stage to a variety of angles and/or download sample photographs from the camera to the computer. The zCapture program may be used to accomplish those tasks. Previewing the capture and making necessary positional adjustments may be used to prevent “drift” (when the object seems to move from side to side as the object stage rotates) in the final captured images.

1.5. Data Collection with zCapture Several capture scripts are supplied with zCapture. Script “cap90” can be used for final data sets with one image per degree of object stage rotation in a 90-degree range. Script “cap360” is used for final data sets with one image every four degrees in a 360-degree range. Script “cap10” can be used for preview data sets, with images every ten degrees over the same 90-degree range. A preview data set can be created much faster, and will allow preview of correct lighting after post-processing without waiting for a full 90-image capture. Finally, the “cap” script can be used to create a completely customized data set by choosing a specific number of images and the angular spacing between them.

To start the data collection process, the camera's AE LOCK feature is turned on and a picture manually taken, as described in sections above. The focus and zoom settings is at the correct setting.

One end of the camera's USB cable is plugged into the camera's USB/serial connector, and the other end plugged into a USB port on the computer. The camera's LCD monitor will shut off, indicating that the connection is established.

The zCapture program is executed. At the “choose a script” prompt, “cap90” (or “cap10”) is entered. A prompt will ask for a destination directory for the captured images. The name of the desired directory (which does not already exist) is entered. A full path such as “C:\myCapture” may be specified. If only the directory name such as “myCapture” is entered, the script will create the directory within the zCapture program's directory. This will be the same directory name supplied to the ZProcess program in the post-processing step. Now the object stage will rotate, and the camera will start taking pictures. The “cap90” script takes about 15 minutes to capture a full data set. When the script finishes, additional scripts may be executed or Enter may be pressed to exit the program (and then any key may be pressed to close the window).

1.6. Data Collection Summary

The following is a brief summary of the steps during image data collection. 1) The object is centered on the object stage, and is configured to stay in frame at all angles; 2) The camera is oriented substantially level with the object, approximately 9 to 12 inches away; 3) The object stage controller is plugged in, turned on, and connected to the computer; 4) The camera is plugged in and the lens cover removed; 5) The backdrop is evenly lit at all angles; 6) The camera is placed in record mode to capture images; 7) The camera AE-Lock is deactivated; 8) The white balance, aperture, and shutter speed are adjusted as desired for good images; 9) The AE Lock is activated, and a picture taken to lock settings; 10) The focus and zoom are set as desired for good images; 11) Camera memory is optionally initialized before capturing images; 12) Camera is connected to computer for image transfer; 13) zCapture program is run; 14) A desired capture script is chosen (e.g. cap360); 15) A destination directory name is specified for capture images; 16) Images are captured automatically by the software.

2.0 Post-Processing with the Create Process

In this step, the “create” program described below according to this example of the present invention is executed. The name of the directory containing the image data should be entered in the program dialogue box. If an invalid directory name is entered, the program will display an error message and exit.

The post-processing tool has two “CreateGUI” windows. The object display window shown in FIG. 6 shows the object as it would appear in the Viewer GUI if it were exported using the current post-processing parameters. This window functions just like the Viewer GUI, though the response time is slower because the post-processing and compression are performed on each step. This window and its controls may be used to check the results during the post-processing parameters adjustment described below.

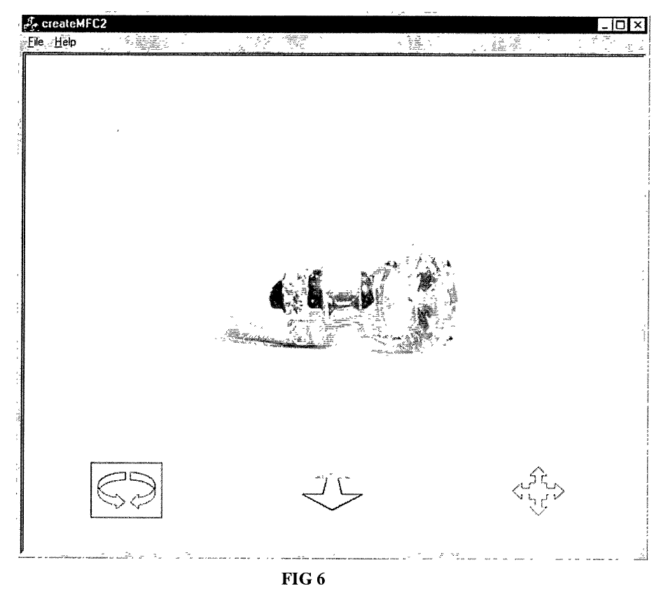

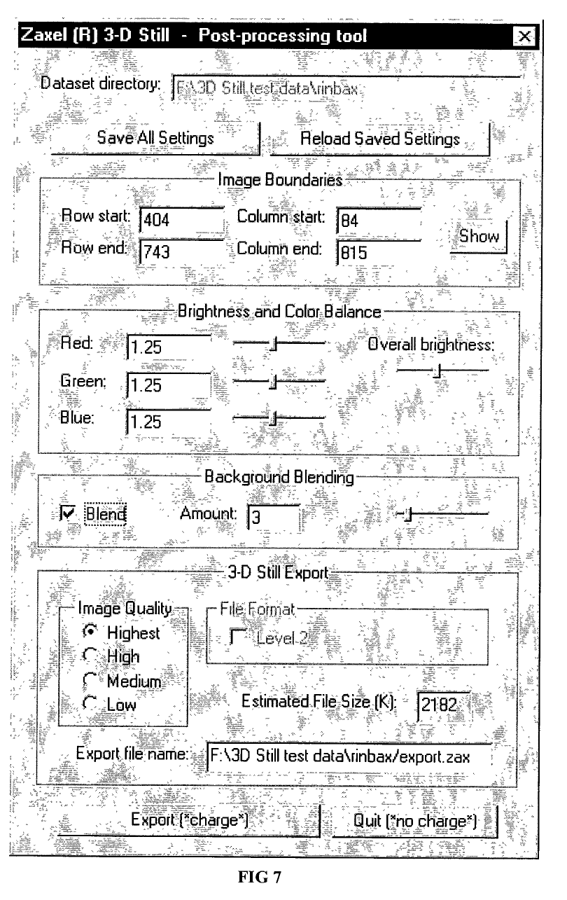

The other window controls the post-processing parameters (see FIG. 7). They can be tuned in any order, but the procedure described below is used for best results.

At any point in the post-processing stage, the “Save All Settings” button may be pressed to save the current post-processing parameters (see FIG. 8). If the program is terminated and later resumed, the parameters will be restored to their last saved state. Pressing “Reload Saved Settings” will also restore the post-processing parameters to their last saved state.

2.1. Subimage Selection

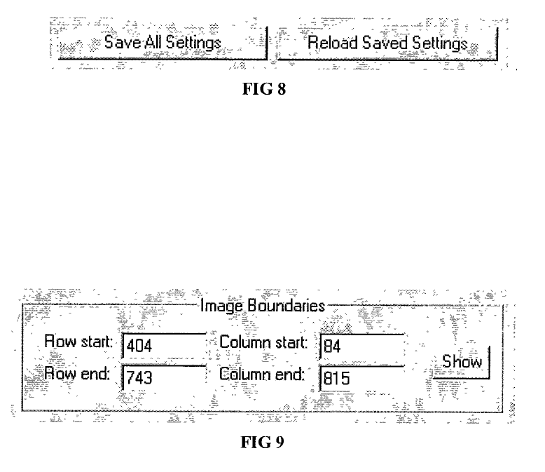

The Image Boundaries section of the control window determines which region, or “subimage”, of the source images will be used (see FIG. 9). It is frequently necessary to “crop” excess background areas from the image.

a. First, the Show button is clicked. A dotted rectangle will appear around the current subimage in the object display window. (The Show button changes to become the Hide button.)

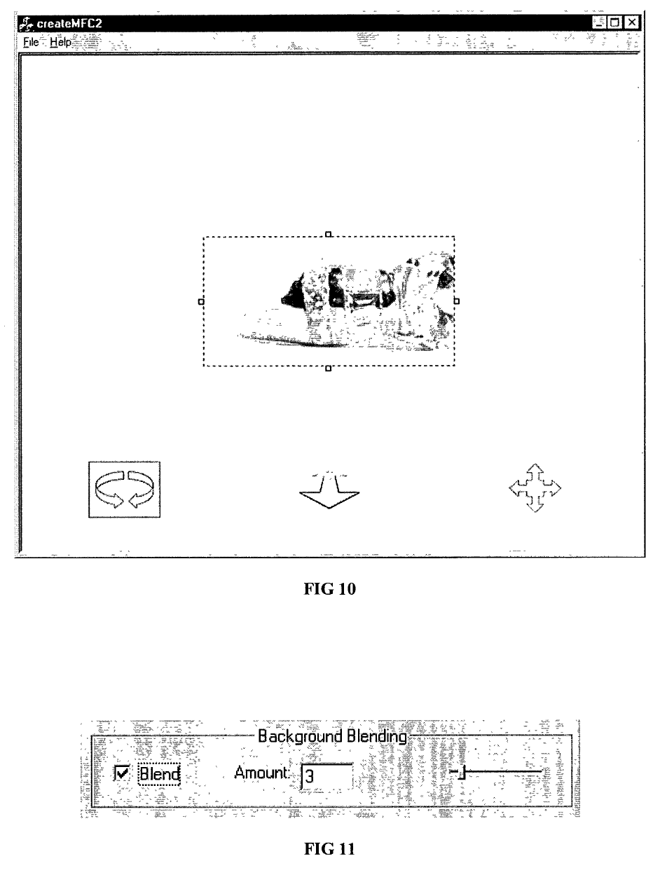

b. Second, the sides of the rectangle may be dragged—and/or the numbers may be typed in the row and column start and end controls—the subimage may be adjusted so that it contains only the object of interest (see FIG. 10). The on-screen rotation control (in the object display window) may be used to check that the object isn't clipped in any of the images.

c. Third, the Hide button is clicked to turn off the dotted rectangle. (Adjustment to the numeric values is still possible in the Image Boundaries controls.)

2.2. Background Blending

The Background Blending section of the control window determines how aggressively the white background from the object stage will be merged with the white background of the object display window (see FIG. 11). The “Blend” checkbox controls whether this feature is active at all. (Clearing the checkbox is equivalent to setting the Amount to zero.) The “Amount” control—or the slider—may be adjusted to change the amount of blending. If the Amount parameter is too low, the white object stage covering may not fully blend in with the display window background. If the parameter is too high, it may begin to bleach color from the object of interest.

Images typically respond well to Amount values between 0 and 30. For convenience, the slider is limited to that range, but any number can be entered into the Amount box.

2.3. Color Adjustment

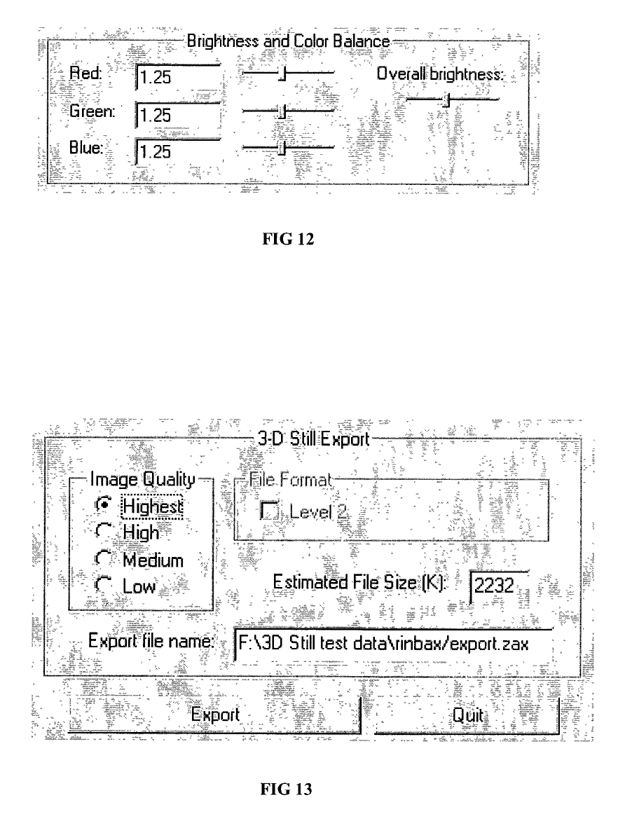

By altering the “Red”, “Green”, and “Blue” parameters in the “Brightness and Color Balance” section of the control window, the color balance of the imaged object can be adjusted to improve the object's appearance (see FIG. 12). The slider next to each numeric value adjusts that value. The “Overall brightness” slider adjusts all three colors together, maintaining their relative proportions.

2.4. File Export

The “Image Quality” radio buttons in the “3-D Still Export” section of the control window allow quality adjustment (specifically, the resolution) of the image (see FIG. 13). Lower quality images will result in a smaller exported file. This section of the control window displays an estimate of the file size of an exported data set with the current parameters. There is also a control in this section where one can specify the file name where the next exported file will be saved.

When all the post-processing parameters have been adjusted so that the object appears as desired, “Export” button may be pressed to produce a 3D Still Image (“.zax”) file that can be viewed with the Viewer GUI. Processing the data may take a few minutes; when the processing is finished, the results will be written to the file name shown in the “Export file name” box.

The process and system of the present invention has been described above in terms of functional modules in block diagram format. It is understood that unless otherwise stated to the contrary herein, one or more functions may be integrated in a single physical device or a software module in a software product, or one or more functions may be implemented in separate physical devices or software modules at a single location or distributed over a network, without departing from the scope and spirit of the present invention.

It is appreciated that detailed discussion of the actual implementation of each module is not necessary for an enabling understanding of the invention. The actual implementation is well within the routine skill of a programmer and system engineer, given the disclosure herein of the system attributes, functionality and inter-relationship of the various functional modules in the system. A person skilled in the art, applying ordinary skill can practice the present invention without undue experimentation.

While the invention has been described with respect to the described embodiments in accordance therewith, it will be apparent to those skilled in the art that various modifications and improvements may be made without departing from the scope and spirit of the invention. Accordingly, it is to be understood that the invention is not to be limited by the specific illustrated embodiments, but only by the scope of the appended claims.

We claim:

1. A image-based rendering system for generating multiple viewpoint images of a subject, comprising:
an imaging device;
means for capturing a set of images of said subject from multiple viewpoints using said imaging device;
an image processing system for storing, processing, and compressing a plurality of images of said subject into a first compressed format, and at least partially transcoding said first compressed format to a second compressed format for selecting one or more images from said second compressed format for generating said multiple viewpoint images of a subject.

2. An image-based rendering system as in claim 1, further comprising a first graphic user interface for interaction with said image processing system.

3. An image-based rendering system as in claim 1, wherein said first compressed format comprises a sequential compressed image format.

4. An image-based rendering system as in claim 1, wherein said second compressed format comprises a randomly accessible compressed image format such that individual images from said set of images may be selected for display or further processing.

5. An image-based rendering system as in claim 1, wherein said transcoding said first compressed format to a second compressed format includes generating at least an intermediate file between said first compressed format and said second compressed format wherein said intermediate file correspond to at least one of said set of images of said subject.

6. An image-based rendering system as in claim 5, wherein said intermediate file is an uncompressed file.

7. An image-based rendering system as in claim 5, wherein said intermediate file is a compressed file.

8. An image-based rendering system as in claim 1, wherein said means for capturing a set of images includes a means for capturing positional data corresponding to each captured image.

9. An image-based rendering system as in claim 1, wherein said multiple viewpoint images comprise at least one interpolated image, said interpolated image being generated from said one or more images from said second compressed format.

10. An image-based rendering system as in claim 1, wherein said image processing system is a computing device.

11. An image-based rendering system as in claim 11, wherein said processing a plurality of images includes processing said images with a background subtraction algorithm in said computing device.

12. A method of generating viewpoint images of a subject from a set of captured images, comprising the steps of:
providing a set of captured images;
compressing the set of captured images to a first compressed format;
at least partially transcoding the first compressed format to a second compressed format such that captured images within the second compressed format are randomly accessible;
generating a viewpoint image of the subject using the second compressed format.

13. A method as in claim 12, wherein said first compressed format comprises a sequential compressed format.

14. A method as in claim 12, wherein said second compressed format comprises a randomly accessible compressed format, such that individual images from said set of captured images may be selected for display or further processing.

15. A method as in claim 12, wherein said providing step includes providing positional information with said set of captured images.

16. A method as in claim 12, wherein said generating step comprises a step of using said positional information for generating said images.

17. A method as in claim 16, further comprising a step of interpolating an image using two or more of said captured images and said positional information.
